(19) United States
(12) Patent Application Publication
(10) Pub. No.: US 2005/0196265 A1
(43) Pub. Date: Sep. 8, 2005

(54) Forklift protection pad

(76) Inventors: Richard Frederick Moore, Arvada, CO (US); Robert Lee Burton, Aurora, CO (US)

Correspondence Address: FAEGRE & BENSON LLP;PATENT DOCKETING, 2200 WELLS FARGO CENTER, MINNEAPOLIS, MN, 55402, US

(21) Appl. No.: 10/795,806

(22) Filed: Mar. 8, 2004

(51) Int. Cl. B60P 1/04

(52) U.S. Cl. 414/785

(57) ABSTRACT

An apparatus for protecting vehicles and products being loaded and moved by means of a forklift. By attaching the invention to the front of the forklift mast, the product, or pallet the product is on, is moved forward to the end of the fork lift tines so that they are not prtotruding from underneath the pallet thus preventing damage caused by the tines. The invention also prevents damage to the side of vehicle doors. Being made by a reaction injection molding, the invention is made of a hard rubber material that absorbs the impact of any contact made. The invention is also of a non skid material so the load will remain stabilized. The invention is movable to accomodate any size load.

### FIELD OF INVENTION

This invention relates to a forklifts, and more particularly, an attachment apparatus for the protection of vehicles being loaded by a forklift as well as the materials being loaded.

### BACKGROUND OF INVENTION

Forklift damage to vehicles and materials is and has been prevalent because the tines of the forklift often protrude from the front of a pallet or goods being loaded. This protrusion is most often out of view of the forklift operator. In addition damage is done to the door frames of the vehicle being loaded by the sides of the forklift mast as the fork enters the vehicle door. This invention will prevent, or at the very least, diminish these damages.

### BRIEF DESCRIPTION OF DRAWINGS

FIG. 1 shows where the protection pad, although height adjustable, is mounted on the forklift mast.

FIG. 2 shows the rear view of how the protection pad is mounted and secured to the forklift mast.

FIG. 3 shows a closer view of the rubber clamps seen in FIG. 2 used to secure the protection pad to the forklift mast's vertical bars.

FIG. 4 shows a closer view of the channel bracket seen in FIG. 2 used to secure the protection pad to the forklift mast vertically.

### DETAILED DESCRIPTION OF THE INVENTION

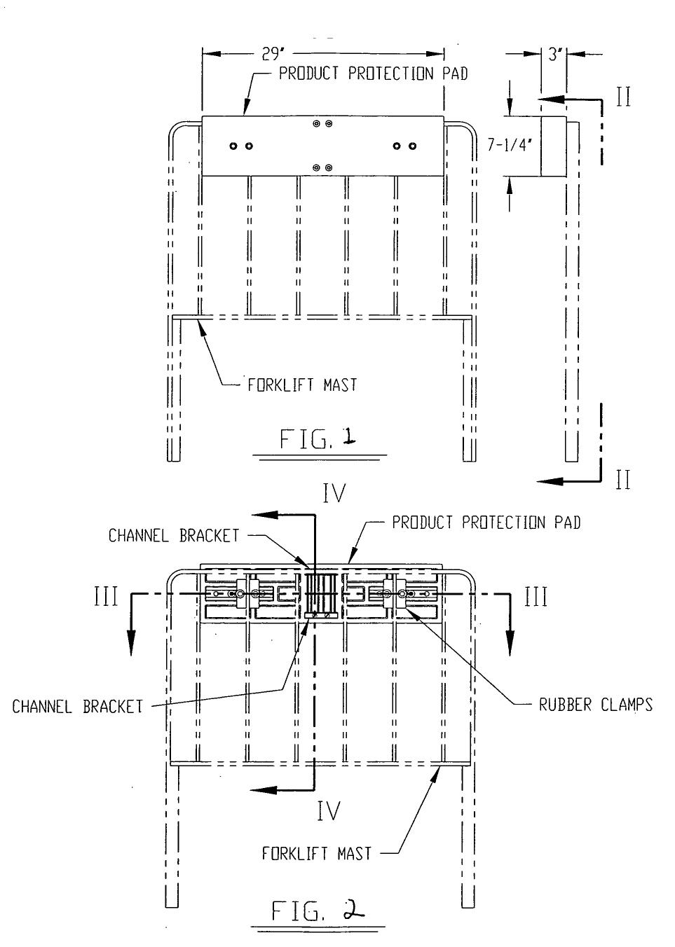

With reference to the FIGURES in the brief description and using those same like reference numerals as the like components thereof, FIG. 1 illustrates the front and side view of the invention as it looks mounted on the forklift mast. The invention is to be manufactured with a molding process commonly referred to as reaction injection molding or RIM. After the mold is removed ⅜ holes are drilled in the specified locations as shown. The invention itself as one embodiment being 29′×7¼′×3′.

FIG. 2 shows the back view of the invention shown in FIG. 1 as well as the adjustable rubber clamp mounting device and channel bracket components and their respective locations as it is mounted on the top of the forklift mast, noting that the invention may be rotated and placed at the bottom of the mast as well.

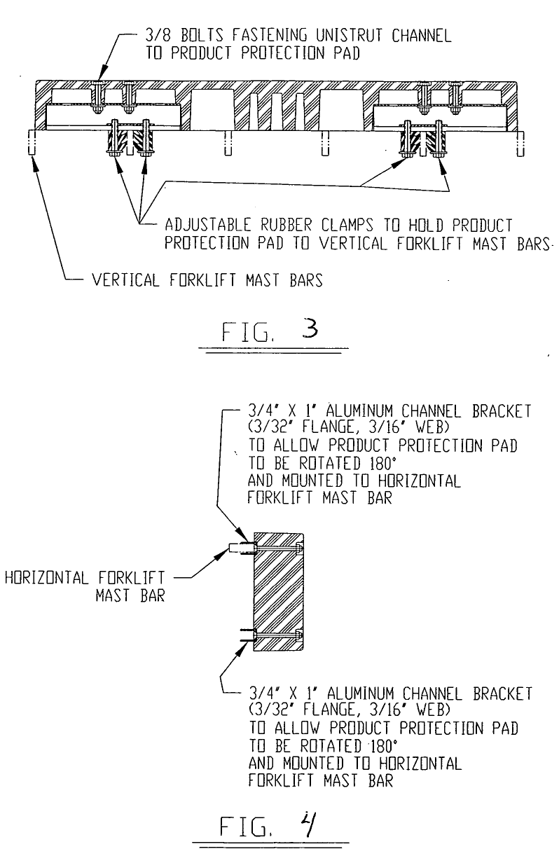

FIG. 3 shows the top view of the invention shown in FIG. 1 and the mounting components in FIG. 2. More precisely it shows the unistrut channel and where and how it is mounted to the inside of the protection pad by installing ⅜ bolts through the ⅜, hole previously rilled at both ens of the pad discussed in FIG. 1. It shows in closer detail the two rubber clamps shown in FIG. 2. The drawing demonstrates that the rubber clamps are mounted to the inside of the protection pad also using ⅜′ bolts and how it is mounted so that it is adjustable to the width of the verticle forklift mast bars.

FIG. 4 shows in closer detail the channel bracket that is pointed out in FIG. 2 and is installed on the back of the invention using bolts of the same size as depicted in FIG. 1 in the center of the invention. This channel bracket is a ¾′×1′ aluminum bracket with a 3/32′ flange and 3/16′ web. This bracket allows the invention to also attach to the top or bottom horizontal bars of the forklif mast depending on the users preference.

1. An apparatus for attachment to a forklift to prevent damage vehicles and other objects, the apparatus comprising:
a. of a 29′×7¼′×3′ reaction injection molded rubber;
b. adjustable rubber clamps to hold invention to verticle forklift mast bars;
c. channel bracket to hold invention to horizontal forklift mast bar.

2. An apaprararus according to claim 1 wherein the apparatus being attached to the forklift mast shifts the product forward so the tines of the forklift do protrude or protrude as far so they don't cause damage.

3. An apparatus according to claim 1 wherein the apparatus being made of had rubber in a reaction injection mold method aids in absorbing shock should impact occur.
